(19) United States
(12) Patent Application Publication
(10) Pub. No.: US 2009/0255907 A1
(43) Pub. Date: Oct. 15, 2009

(54) WELD-ON-WELD DEVICE

(76) Inventor: Steven L. Pankhurst, Oshawa (CA)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(21) Appl. No.: 12/423,092

(22) Filed: Apr. 14, 2009

(30) Foreign Application Priority Data
Apr. 14, 2008 (CA) 2,629,041

(51) Int. Cl. B23K 9/04

(52) U.S. Cl. 219/76.14; 219/125.1

(57) ABSTRACT

An apparatus for forming a metal body of a predetermined shape by the deposition of a weld material. The apparatus comprises a support base on which the body can be formed, a means for rotating the base about an axis, a welding torch for depositing weld material to form the body, the body, as it is formed, being supported on the base as it rotates. The welding torch is operable for linear movement, relative to the base, in at least two perpendicular directions in a plane. One of those directions is parallel to the axis of rotation of the base. There is also provided a template support located remotely from the welding torch. Guiding means for guiding the linear movement of the welding torch relative to the base are also provided, the guiding means comprising means for mechanically following a shape of a template when secured on the template support. In operation as the base rotates, weld material is deposited to form a three-dimensional body having a profile similar in shape to that of the template.

### CROSS REFERENCE TO RELATED APPLICATIONS

This application claims the benefit of priority to Canadian patent application No. 2,629,041 filed Apr. 14, 2008.

### FIELD OF THE INVENTION

The present invention relates to an apparatus for forming a metal body of a predetermined shape by the deposition of a weld material, using a welder such as a MIG welder, a GMAW welder, a TIG welder or a GTAW welder.

### BACKGROUND OF THE INVENTION

Weld-on-weld techniques require the creation of welds on top of welds and can provide any shape of metal object. MIG, GMAW, TIG or GTAW welders operate by feeding an inert gas and a metal wire through a torch and energizing and melting the wire with an electric voltage. When the energized, molten wire hits the base metal, it welds itself to the surface. Weld-on-weld techniques are known and represented, for example, in the subject matter of the following references:
U.S. Pat. No. 6,825,433 (Wright et al.) ‘Apparatus And Method For Forming A Body’
U.S. Pat. No. 6,825,432 (Jones) ‘Apparatus And Method For Forming A Body’
U.S. Pat. No. 6,274,839 (Stone et al.) ‘Method And Apparatus For Building Up A Workpiece By Deposit Welding’
U.S. Pat. No. Re. 35,756 (Schneebeli et al.) ‘Method Of Production Of Workpieces By Welding Equipment’
U.S. Pat. No. 2,433,966 (Van Keuren) ‘Method Of Making Tubular Members By Progressive Helical Welding’
U.S. Pat. No. 3,665,143 (Ujiie) ‘Method Of Constructing Substantially Circular Cross-Section Vessel By Welding’
U.S. Pat. No. 4,842,186 (Doyle et al.) ‘Method And Apparatus For Building A Workpiece By Deposit Welding’
U.S. Pat. No. 3,985,995 (Brandi, deceased et al.) ‘Method Of Making Large Structural One-Piece Parts Of Metal, Particularly One-Piece Shafts’
U.S. Pat. No. 5,786,562 (Larson) ‘Method And Device For Producing Three-Dimensional Bodies’
U.S. Pat. No. 4,894,505 (Malone et al.) ‘Modified Rotating Reusable Preform’
U.S. Pat. No. 4,892,990 (Acheson) ‘Automatic Welding Apparatus For Weld Build-Up And Method Of Achieving Weld Build-Up’
U.S. Pat. No. 5,207,371 (Prinz et al.) ‘Method And Apparatus For Fabrication Of Three-Dimensional Metal Articles By Weld Deposition’
U.S. Pat. No. 6,744,005 (Beyer et al.) ‘Method For Producing Shaped Bodies Or Applying Coatings’
U.S. Pat. No. 4,775,092 (Edmonds et al.) ‘Method And Apparatus For Building A Workpiece By Deposit Welding’
U.S. Pat. No. 4,671,448 (Million et al.) ‘Method Of Preparing Structural Components Having A Symmetrically Curved Wall By Buildup Welding’
U.S. Pat. No. 4,621,762 (Bronowski) ‘Device For Building Up A Workpiece By Deposit Welding’
U.S. Patent Application No. 2002/0139780 (Jones et al.) ‘Method For Forming A Body’
U.S. Patent Application No. 2002/0139778 (Jones) ‘Method And Apparatus For Forming A Workpiece’
U.S. Patent Application No. 2003/0024916 (Wright et al.) ‘Apparatus And Method For Forming A Body’
U.S. Patent Application No. 2003/0127431 (Pratt et al.) ‘Apparatus And Method For Forming A Body’
   It is an object of the present invention to provide a novel apparatus and method for forming metal bodies by the deposition of a weld material.

### SUMMARY OF THE INVENTION

In accordance with the present invention there is provided an apparatus for forming a metal body of a predetermined shape by the deposition of a weld material. The apparatus comprises a support base on which the body can be formed and a means for rotating the base about an axis. A welding torch is provided for depositing weld material to form the body, the body, as it is formed, being supported on the base as it rotates. The welding torch is operable for linear movement, relative to the base, in at least two distinct directions in a plane. There is also provided a template support located remotely from the welding torch. Guiding means for guiding the linear movement of the welding torch relative to the base are also provided, the guiding means comprising means for mechanically following a shape of a template when secured on the template support. In operation as the base rotates and the guiding means follows the shape of the secured template, weld material is deposited to form a three-dimensional body having a profile similar in shape to that of the template.

In one example embodiment, the welding torch is operable for linear movement relative to the base, in at least two perpendicular directions in a plane, one of those directions being parallel to the axis of rotation of the base.

In another example embodiment of the present invention the guiding means comprises a first elongated arm positioned perpendicular to the axis of rotation of the base. It is connected to a second arm oriented parallel to the base for slidable movement both in its longitudinal direction and in a direction parallel to the axis of rotation of the base. The welding torch is secured to the first arm so that it is directed towards an end of the base.

The apparatus of the present invention is effective in forming shaped metal products and may be assembled for a fraction of the cost of apparatus with computer controlled robotic arms and special programs.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the present patent specification as a whole.

### BRIEF DESCRIPTION OF THE DRAWINGS

These and other advantages of the invention will become apparent upon reading the following detailed description and upon referring to the drawings in which:

FIG. 1 is a perspective, schematic view of an apparatus for forming a metal body in accordance with the present invention.

FIG. 2 is a perspective, schematic view of an alternative embodiment of the apparatus of claim 1.

FIG. 3 is a detailed perspective view of the welding torch control arrangement of the apparatus of FIGS. 1 and 2.

The present invention will now be described by way of a non-limiting description of certain detailed embodiments.

### DETAILED DESCRIPTION OF THE PREFERRED EMBODIMENTS

In the following description, similar features in the drawings have been given identical reference numerals where appropriate. All dimensions described or suggested herein are intended solely to illustrate an embodiment. These dimensions are not intended to limit the scope of the invention that may depart from these dimensions.

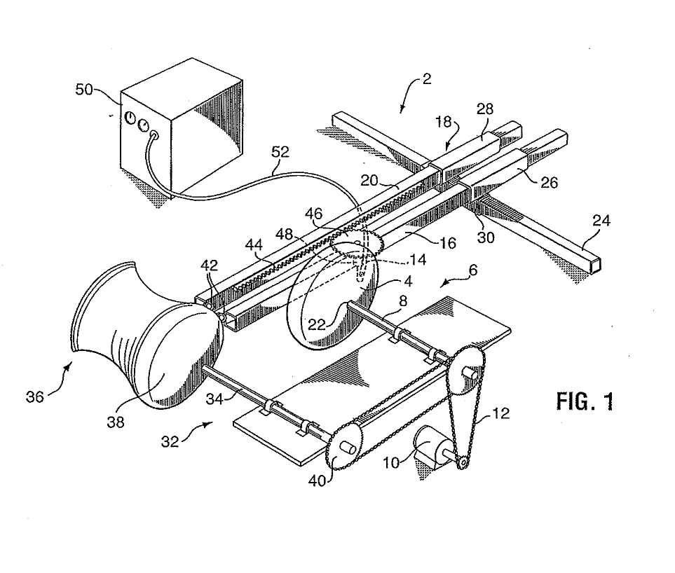

Turning to FIG. 1 there is illustrated an apparatus 2 for forming a metal body 4 of predetermined shape, by the deposition of a weld material. Apparatus 2 comprises a support base 6, on which the body can be formed. In the illustrated embodiment, this support base 6 is in the form of a shaft 8 rotatable for example by a variable speed motor 10 connected to shaft 8 by means of a reducing ratio chain and sprocket assembly 12.

A welding torch 14 for depositing weld material to form body 4 on shaft 8 as it rotates, is provided, secured to arm 16 of arm assembly 18, for movement in two (in this case perpendicular) distinct directions in a plane, one of those directions in this case being in a longitudinal direction parallel to the axis of rotation of shaft 8, and the other being in a lateral direction perpendicular thereto. Arm assembly 18 also comprises a second arm 20, parallel to arm 16 and spaced therefrom in a direction away from the proximal end 22 of shaft 8, and stationary arm 24 in this case positioned at right angles to arms 16 and 20. Arms 16 and 20, at one end of each, are for example slidably secured within sleeves 26 and 28 respectively, sleeves 26 and 28 being rigidly secured to a further sleeve 30, within which stationary arm 24 is slidably mounted. In this way the movement of welding torch 14 in the two perpendicular directions is accomplished. At the other end of arms 16 and 20, and spaced from shaft 8 and welding torch 14, is a template support 32. In the illustrated embodiment, that support is in the form of a motor driven rotating shaft 34. It supports a template 36 which, in the illustration, is in the form of a vase 38. Variable speed motor 10, through chain and sprocket assembly 12, may be used to drive a chain and sprocket assembly 40 to turn template shaft 34. Rollers 42, or any other appropriate conventional mechanism such as a slidable material or an electronic sensor such as an electronic eye (not illustrated) may be used, at the proximal ends of arms 16 and 20, to roll on the surface of template 36, as it is rotated on shaft 34, and cause sliding movement of the arms 16 and 20. That sliding movement of arm 16 in both the longitudinal and lateral directions as dictated by the corresponding roller 42 and on template 36, will govern the lateral and longitudinal positioning of welding torch 14 with respect to shaft 8, so that the shape of the body 4 being formed conforms to that of template 36.

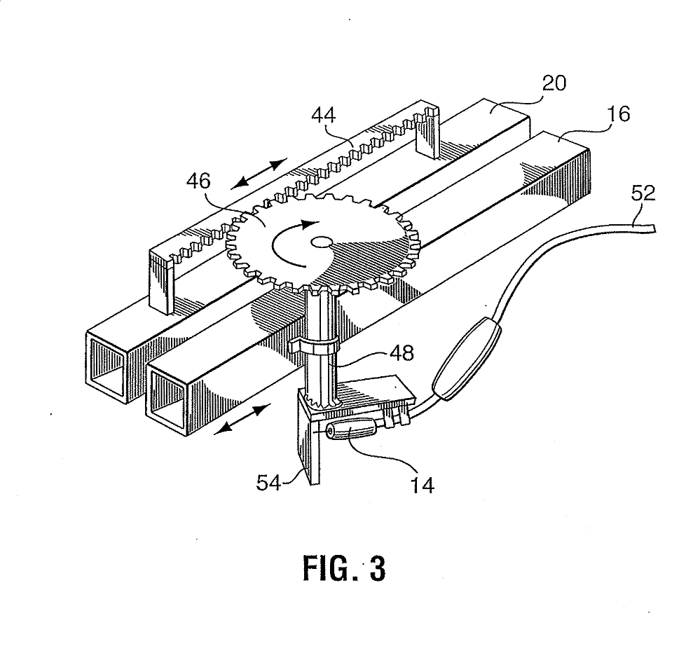

The angle of welding torch 14, within the plane that the torch moves in longitudinal and lateral fashion with respect to shaft 8, is also adjustable. This is accomplished by second arm 20, and, for example a rack 44 interacting with a pinion 46, rotation of pinion 46 being governed by the movement of arm 20, and rotation of pinion 46 being translated into rotative movement of shaft 48 (FIG. 3) to which welding torch 14 is secured. This pivotal movement of the welding torch 14 ensures that welding torch 14 is properly angled, as governed by the location of the arms 16 and 20 on template 36, for proper shaping of body 4 at the end of shaft 8.

A MIG or GMAW welder or a TIG or GTAW welder 50 provides wire and gas, through cable 52, to welding torch 14, and energizes the wire while feeding the wire through torch 14.

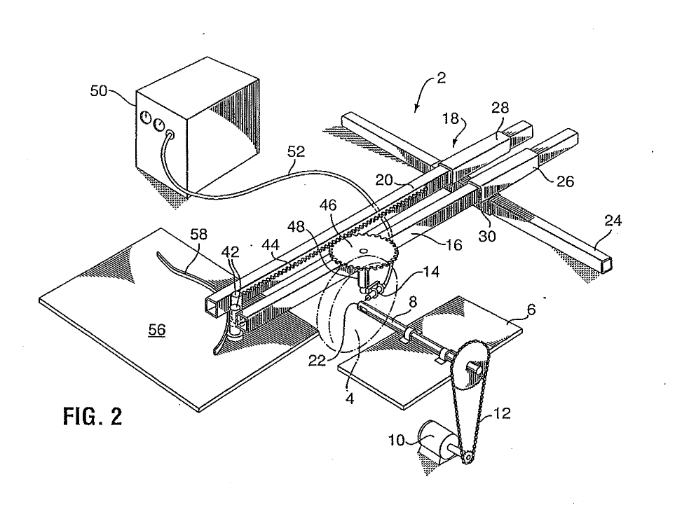

The distance of torch 14 from body 4 must remain fairly constant. This is accomplished by the body 4 itself, as it is formed. As body 4 gets larger, it pushes against a push plate 54 secured to welding torch 14, thereby causing the torch to be physically pushed away from metal body 4. (Push plate 54 has only been illustrated in FIG. 3, for the sake of clarity. Push plated 54 would also normally be illustrated in FIGS. 1 and 2, but for the sake of clarity of these figures, that feature has been omitted from these drawings.) Of course push plate 54 may be replaced by any other conventional means of moving a torch away from the body being formed.

Alternatively, motors (not illustrated) may control the movement of the torch (electrically) instead of these mechanical arms.

The “angle” of the torch 14 is preferably kept perpendicular to, or close to that, with respect to the axis of rotation of shaft 8, near its proximal end 22. Minor angular adjustment of that angle however is provided by the rack 44 and pinion 46 assembly, in the manner previously described.

In operation, by continually welding on top of another weld, at the proximal end 22 of shaft 8 with respect to welding torch 14, the metal will build on top of itself in the sense that each new layer of weld becomes the parent metal for the next layer of weld.

There are five different parameters that must be controlled to achieve the desired outcome using apparatus 2:

(1) the position of welding torch 14;

(2) the angle of that torch;

(3) the power output of welder 50;

(4) the speed of rotation of body 4 on shaft 8; and

(5) the distance of torch 14 from the body 4.

The weld material maybe selected from the group consisting of stainless steel, steel aluminum, titanium, brass, bronze and plastic.

In operation, the position of welding torch 14 is controlled by template 36 and by the movement of the arms 16 and 20 on stationary arm 24, as well as the movement of rack 44 and pinion 46 on arm 16, which governs the angle of welding torch 14. As the metal body is continually formed, the torch 14 follows the shape of template 36 on template support 32. The power output is controlled at welding machine 50. This control controls the thickness of the wall of the body. The higher the power output and wire speed, the thicker the weld bead and therefore the thicker the product wall will be.

In the alternative embodiment illustrated in FIG. 2, template support, instead of being a shaft 34 as in FIG. 1, is formed by a table 56 on which is supported a template form 58. Otherwise the operation of apparatus 2 in FIG. 2 is similar to that in FIG. 1. The location of rollers 42 on the ends of arms 16 and 20, with respect to template form 58, will be translated into a metal body 4 (phantom) having a circular cross-section, the overall appearance of the outside of metal body 4 being dictated by the shape of template 58.

The movement of arms 16 and 20 longitudinally, with respect to template 36 or 58, in FIGS. 1 and 2, may be carried out manually or mechanically by appropriately moving arms 16 and 20 longitudinally along stationary arm 24. In operation, shaft 8 rotates at a speed that maintains the correct travel speed for the arms 16 and 20 longitudinally with respect to the template 36, along stationary arm 24. The welder 50 is set up to achieve the desired weld thickness. The weld thickness will be the wall thickness of the finished product. Generally a higher shaft speed combined with a lower welder power output will produce a thinner wall, and a slower shaft speed with a higher welder output will produce a thicker wall.

The speed of rotation of the product is of course controlled by variable speed motor 10. Shaft 8 rotation and power output of the welding machine 50 must be matched to get a smooth, continuous weld. The speed of rotation of shaft 8 must also be reduced as the product diameter gets larger.

As shaft 8 continues to rotate, a layer of weld is deposited on shaft 8. Once the first rotation is completed, and shaft 8 continues to rotate, the next weld layer is welded to the first weld layer. As shaft 8 continues to operate, each additional revolution of the shaft will create an additional layer of weld. As the weld layers continue to build on each other, the body 4 starts to form. The diameter of the product starts to increase. In the illustrated embodiment, where the body is a vase 38, FIG. 1 illustrates the body at about 20% completion. As the diameter of body 4 increases, the speed of rotation of the shaft must be decreased to maintain the original travel speed. This is done by reducing the speed of the variable speed motor 10. This can be done manually or automatically.

The shape of the product is controlled by changing the position of the welding torch 14, as previously indicated, that positioning being controlled by the template 36 or template form 58, of, respectively FIGS. 1 and 2. As each new layer is deposited, the position of torch 14 is changed slightly as it follows the shape of the template.

It is envisaged that apparatus 2 could include electric controls such as, but not limited to, sensors, motors, actuators and switches.

While, in the illustrated embodiment, arms 16 and 24 have been shown as associated with each other in perpendicular fashion, they may be associated at angles other than 90 degrees, for proper operation of apparatus 2 as will be apparent to ones skilled in the art. That angle may be determined by the nature of the body to be formed. Similarly, apparatus 2 may be configured so that welding torch 14 is secured to arm 16 for movement in directions which are not parallel to the axis of rotation of shaft 8 and in a second direction which is perpendicular thereto. Again, one skilled in the art will be readily able to configure apparatus 2 so that welding torch 4 is moveable in appropriate directions.

Although the present invention has been described by way of a detailed description in which various embodiments and aspects of the invention have been described, it will be seen by one skilled in the art that the full scope of this invention is not limited to the examples presented herein. The invention has a scope which is commensurate with the claims of this patent specification including any elements or aspects which would be seen to be equivalent to those set out in the accompanying claims.

1. An apparatus for forming a metal body of a predetermined shape by the deposition of a weld material, the apparatus comprising:
a support base on which the body can be formed;
means for rotating the base about an axis;
a welding torch for depositing weld material to form the body, the body, as it is formed, being supported on the base as it rotates, the welding torch being operable for linear movement, relative to the base, in at least two distinct directions in a plane;
a template support located remotely from the welding torch;
guiding means for guiding the linear movement of the welding torch relative to the base, the guiding means comprising means for mechanically following a shape of a template when secured on the template support, wherein, in operation as the base rotates and the guiding means follows the shape of the secured template, weld material is deposited to form a three-dimensional body having a profile similar in shape to that of the template.

2. The apparatus of claim 1 further comprising a template for defining the profile of the body, the template being releasably secured to the template support.

3. The apparatus of claim 1, wherein the welding torch is connected to a welder selected from the group comprising a MIG welder, a GMAW welder, a TIG welder and a GTAW welder.

4. The apparatus of claim 3 further comprising means for controlling the power output of the welder and the speed of rotation of the rotation means, the power output of the welder and the speed of rotation of the rotation means being determinative of the thickness of the weld material at the welding torch and therefore determinative of the thickness of the wall of the body.

5. The apparatus of claim 1, wherein the template support comprises a platform positioned in a plane parallel to the plane of the plane of the axis of rotation of the base.

6. The apparatus of claim 1, wherein the welding torch is operable for a linear movement, relative to the base, in at least two perpendicular directions and a plane.

7. The apparatus of claim 6, wherein one of said directions is parallel to the axis of rotation of the base.

8. The apparatus of claim 1, wherein the guiding means comprises a first elongated arm connected for sliding movement to a second elongated arm, the welding torch being secured to the first arm so that it is directed towards an end of the base.

9. The apparatus of claim 7, wherein the guiding means comprises a first elongated arm positioned perpendicular to the axis of rotation of the base and connected for slidable movement both in a longitudinal direction and in a direction perpendicular thereto and parallel to the axis of rotation of the base, to a second elongated arm oriented parallel to the base, the welding torch being secured to the first arm so that it is directed towards an end of the base.

10. The apparatus of claim 9, wherein said first elongated arm has, at an end, a roller to roll along the surface of the template and cause slidable movement of that arm with respect to the base.

11. The apparatus of claim 9, wherein a further elongated arm is provided, parallel to the first arm and spaced therefrom in a direction away from the end of the base, this further arm being connected to said second arm for sliding movement in the elongated direction perpendicular thereto, a roller being provided at the end of this further arm so as to permit rolling along the surface of the template, a rack and pinion mechanism associated with this further arm and the welding torch so as to provide pivotal movement of the welding torch, in the plane of linear movement of the welding torch, so that the angle of the welding torch is properly controlled by the template.

12. The apparatus of claim 11, wherein a push plate is secured to the welding torch so as to bear, during operation of the apparatus, against the body as the body gets larger, to assist in moving the torch away from the body in a perpendicular direction to the axis of rotation of the base.

13. The apparatus of claim 11, wherein the first arm and further arm are slidably secured to the second arm by means of coupled sleeves, a pair of sleeves, within which the first and further arms are slidably mounted being secured to a further sleeve slidably mounted on the second arm.

14. The apparatus of claim 1, wherein the weld material is selected from the group consisting of stainless steel, steel, aluminum, titanium, brass, bronze and plastic.

15. The apparatus of claim 1, wherein the means for rotating the base comprises means for controlling the speed of rotation of the base.

16. The apparatus of claim 1 further comprising means for controlling the angle of welding torch relative to the base.

17. A method of forming a metal body by the deposition of a weld material, the method comprising the steps of:
providing a base on which the body can be formed and providing means for rotating the base;
providing a template for defining a profile of the body; and
supplying a weld material to a welding torch while guiding the welding torch relative to the base in accordance with a shape of the template and rotating the stationary base to form the metal body.
